(19) United States
(12) Patent Application Publication
(10) Pub. No.: US 2007/0050097 A1
(43) Pub. Date: Mar. 1, 2007

(54) Method and device for calling a remote electric car

(76) Inventor: Chiu-Hsiang Lo, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/312,740

(22) Filed: Dec. 21, 2005

(30) Foreign Application Priority Data
Aug. 23, 2005 (TW) 94128743

(51) Int. Cl. G06F 17/00

(52) U.S. Cl. 701/2; 701/22

(57) ABSTRACT

An electric car includes a remote control calling system includes a transmitter and a car, and both of which have an electronic compass for detecting the terrestrial magnetism to obtain an azimuth and calculating the azimuth difference of the two by simple computations. The system automatically controls the direction of the car driving towards a user, and achieves the purposes of simplifying the car structure and facilitating its use.

### FIELD OF THE INVENTION

The present invention relates to an electric car having a remote control calling system, and more particularly to a system having a transmitter and a car, and both having an electronic compass for detecting the terrestrial magnetism to obtain an azimuth and calculating the azimuth difference of the two by a simple computation.

### BACKGROUND OF THE INVENTION

In the structure of a prior art golf car, the golf car is designed to have a function of automatically following a golfer. The golfer just needs to send a signal to the golf car, and the processor of the golf car processes the signal to drive a driving motor, such that the golf car will move according to the position of the golfer. At present, a prior art structure comprises a tracker and. a guider. The guider is carried by the golfer, and the tracker is installed onto the golf car, wherein the tracker includes a first processor, at least two encoders for producing encoded signals, and each encoder includes a control input and is connected to the first processor. The control of the direction of the prior art system works with the tracker having several infrared transmitters which are the devices capable of detecting directions and encoding, and each transmitter can transmit signals at the same time, and the guider sends a feedback RF signal to the tracker and indicates a signal of a particular transmitter is detected, and then the processor will determine the direction. However, the golf car of the prior art system will follow the golfer, and if the golfer walks through a bunk or a pit, the golf car will detour around the bunk. While the golfer has detoured around the bunk and the golf car is still in the middle of the bunk, the golf car will turn accordingly if the golfer makes a turn, and thus the golf car will drop into the bunk. Furthermore, it is not practical for the golf car to follow the golfer all the time during the course of striking the golf ball. As long as the golfer moves, the golf car will move accordingly, and it will affect the golfer or other golfers to strike the golf balls. In addition, the prior art system requires the golf car to transmit signals and the guider to receive signals, and these components consume power all the time, and thus such prior art is not cost efficient.

There is another prior art system that comprises a fixed position receiver, a stepping motor, an infrared detector, and a processor, and the infrared detector is driven to rotate within a wide angle by the stepping motor. Once the infrared detector receives a signal from the transmitter, the infrared detector will determine the direction and drive the servo turner to make turns for the golf car so as to fix the position after the fixed position receiver has received the signal. The processor will compute and memorize the distance between the golf car and the golfer, and then execute the instructions for moving the golf car according to the position and distance and repeating the positioning, detecting, memorizing, and executing processes. However, this prior art system still has the same shortcoming of following the golfer all the time as described above. Obviously, it is not necessary for the golf car to follow the golfer during the course of striking the golf ball. Once the golfer moves, the golf car will move accordingly, and such arrangement will affect the golfer or other golfers striking the golf galls. The prior art system requires fine and complicated components, and thus increasing the cost, and exhausting the components easily.

### SUMMARY OF THE INVENTION

Therefore, it is a primary objective of the present invention to provide a car having a transmitter and a position receiver, and both transmitter and car have an electronic compass module for detecting the terrestrial magnetism to confirm their azimuths. The transmitter sends its azimuth to the car, and the processor of the car compares the two azimuths to compute the azimuth difference. The driving controller drives the driving motor to rotate, so that the car is turned to the zero azimuth difference, and then the car is driven towards the transmitter. The invention can achieve the effects of simplifying the structure, improving the precision, and lowering the cost.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a schematic view of a basic structure of a car according to the present invention;

FIG. 2 is a schematic view of an architecture of a system of the present invention;

FIG. 3 is a schematic view of an azimuth relation according to a first preferred embodiment of the present invention; and

FIG. 4 is a schematic view of an azimuth relation according to a second preferred embodiment of the present invention.

### DETAILED DESCRIPTION OF THE PREFERRED EMBODIMENT

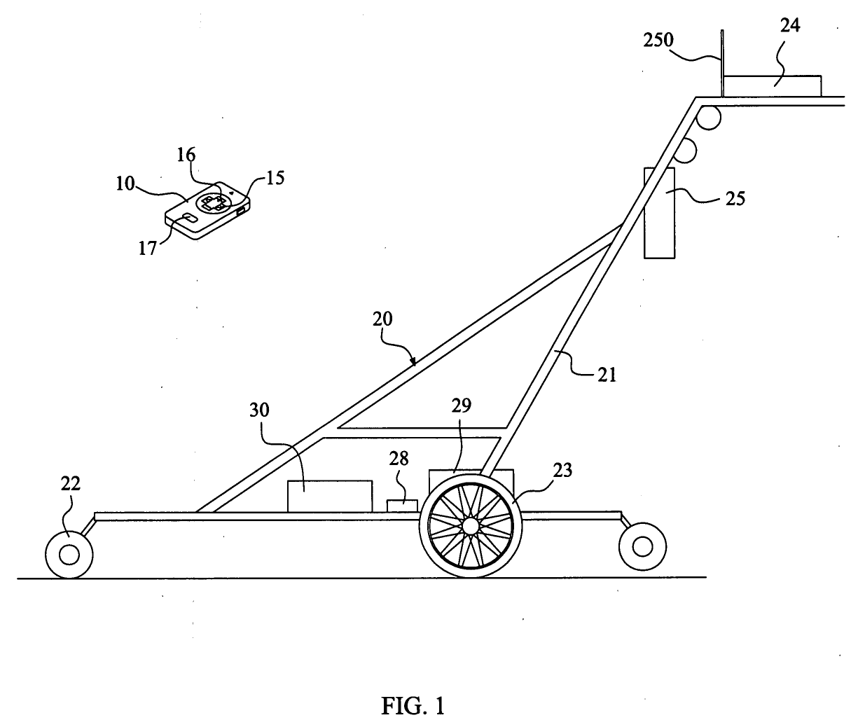

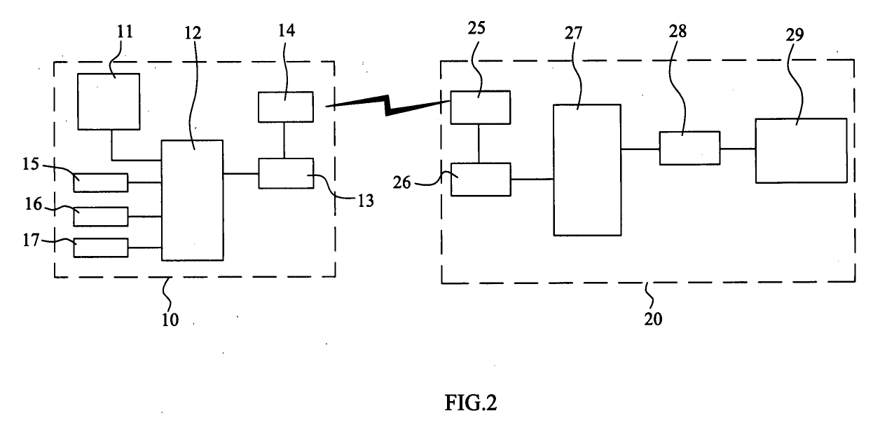

The present invention provides a remote control electric car used for wheelchairs, transportation cars, dining cars or golf cars. Refer to FIGS. 1 and 2 for a golf car having a containing rack for storing golf balls and equipments according to a preferred embodiment of the invention. The present invention involves a caller and a car 20, and the caller caries a position transmitter 10 for producing and transmitting the azimuth data of the caller, wherein the position transmitter 10 comprises an electronic compass module 11, having a sensor for detecting the terrestrial magnetism and producing a first azimuth data of the caller. A first microprocessor 12 converts the first azimuth data into a first azimuth signal. An encoder 13 encodes the first azimuth signal and a radio frequency transmitter 14 which transmits the first azimuth signal.

The car 20 comprises a car body 21 having at least one front wheel 22 installed at the front end of the car body 21 and two driving wheels 23 are installed on both sides of the car body 21. An electronic compass 24 detects the terrestrial magnetism and produces a second azimuth data for the driving direction of the car. A position receiver 25 receives the first azimuth signal comes from the radio frequency transmitter 14. A decoder 26 decodes the received first azimuth signal and a second microprocessor 27 which converts the second azimuth data into a second azimuth signal, and a driving controller 28. At least one electric motor 29 which drives the driving wheel 23 to rotate and at least one battery 30 which supplies the required power.

If the caller aims the position transmitter 10 at the car 20, the electronic compass module 11 of the position transmitter 10 will obtain a first azimuth data of the caller, and the first microprocessor 12 converts the first azimuth data into a first azimuth signal. The first azimuth signal is encoded by the encoder 13 and then transmitted by the radio frequency transmitter 14 to the car 20. The position receiver 25 of the car 20 receives the signal and the decoder 26 decodes the signal. The decoded signal is inputted into the second microprocessor 27 of the car 20 and the second azimuth data produced by the electronic compass 24 of the car 20 is also inputted to the second microprocessor 27 and converted into a second azimuth signal. The second microprocessor 27 compares the first azimuth signal and the second azimuth signal and computes the azimuth difference between the caller and the driving direction of the car 20. If the azimuth difference is zero, the driving direction of the car 20 will aim at the caller, and the second microprocessor 27 will send the forward signal to the driving controller 28. The driving controller 28 will control the motor 29 to rotate and drive the car 20 forward. If the azimuth difference is not zero, the second microprocessor 27 will send out a turning signal to the driving controller 28, and the driving controller 28 will control the motor 29 to rotate and turn the car 20 from its original position until the azimuth difference becomes zero, and then will control the car 20 to go forward.

In a preferred embodiment of the present invention, the car 20 has two motors 29 and each motor 29 is responsible for driving a corresponding driving wheel 23. The driving controller 28 can output two different control signals to the two motors 29 so that the two driving wheels 23 can produce a relative rotary speed difference to turn the direction of the car 20 from its original position.

In a preferred embodiment of the present invention, the position receiver 25 of the car 20 includes a receiving antenna 250 for improving the capability of receiving signals.

Referring to FIGS. 1 and 2 for the operating procedure of the present invention, the caller uses a position transmitter 10 to aim at a desired car 20, such that the transmitter 10 produces a first azimuth data and the processor 12 converts a first azimuth signal and encodes the signal. The transmitter 10 then transmits the first azimuth signal to the car 20. The car produces a second azimuth data and the processor 27 converts the data into a second azimuth signal. If the car 20 receives the first azimuth signal come from the transmitter 10 of the caller, then the first azimuth signal will be decoded. The second azimuth signal will be compared to compute a azimuth difference and the azimuth difference will be used as a signal for controlling the movements of the car 20. The principle of its control is described as follows:

(a) If the azimuth difference is zero, it means that the driving direction of the car 20 aims at the caller, and the car 20 will move forward; and

(b) If the azimuth difference is not zero; then car 20 will turn its direction from the original position until the azimuth difference becomes zero, and then the car 20 will move forward.

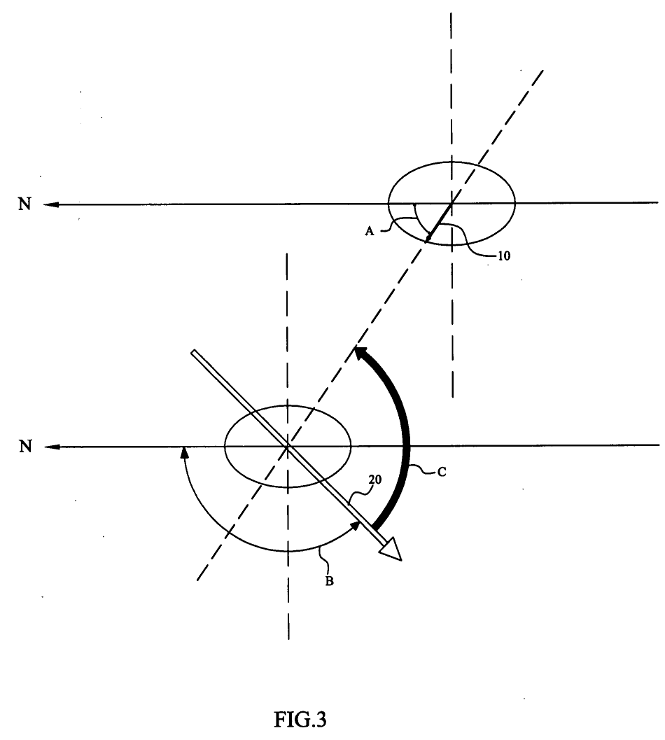

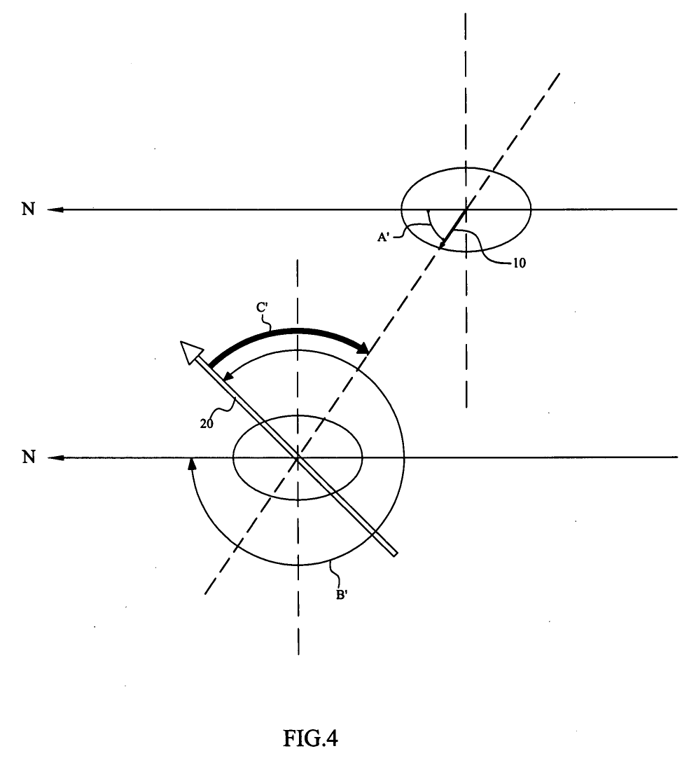

Referring to FIGS. 1 to 4 for the rules of computing the azimuth difference, two examples are used for the description.

### EXAMPLE 1

If the transmitter 10 aims at the car 20, the first azimuth A is equal to 60 degrees, and if the car 20 aims at the second azimuth B which is equal to 135 degrees, then the first azimuth signal will be transmitted to the car 20. The processor 27 of the car 20 will find the inverted angle C of the first azimuth to be 240 degrees, and the second azimuth B is subtracted from the inverted angle C (i.e. 240−135=105 degrees). The azimuth difference C is 105 degrees. The processor 27 will send a turning instruction to the driving controller 28 according to the azimuth difference signal and the driving controller 28 will control the motor 29 to rotate, so that the car 20 will turn 105 degrees counterclockwise from the original position. Therefore, the car 20 will aim at the caller and then an instruction will be sent to control the car 20 to move forward in the direction of the caller.

### EXAMPLE 2

If the transmitter 10 aims at the car 20, the first azimuth A is equal to 60 degrees and the car 20 will aim at the second azimuth B which is equal to 315 degrees. The first azimuth signal is transmitted to the car 20 and the processor 27 of the car 20 computes the inverted angle C of the first azimuth which is equal to 240 degrees. The second azimuth B is subtracted from the inverted angle (i. e. 315−240=−75 degrees) to obtain the azimuth difference C′ which is equal to −75 degrees. The processor 27 will send a turning instruction to the driving controller 28 according to the azimuth difference signal, so that the driving controller 28 is controlled to rotate the motor 29 and the car 20 is turned 75 degrees clockwise from the original position. Therefore the car 20 will aim at the caller, and an instruction is sent to control the car 20 to move forward in the direction of the caller.

In the foregoing two examples, the first azimuth data and second azimuth data uses the pointing line of the electronic compass module as the base, and the azimuth difference is obtained by subtracting the second azimuth from the inverted angle of the first azimuth. If the azimuth difference is positive, then the car will be turned counterclockwise from the original position until the azimuth difference becomes zero. If the azimuth difference is negative, then the car will be turned clockwise from the original position until the azimuth difference becomes zero.

Further, the transmitter 10 of the invention includes a turning control button 15 connected to the first microprocessor 12 for controlling the turning direction of the car 20. If the user finds that there is an obstacle in front of the car 20, the user can press the turning control button 15 to change the driving direction of the car 20 to avoid the obstacle. The transmitter 10 can further includes a speed control button 16 connected to the first microprocessor 12 for controlling the driving speed of the car 20. The transmitter 10 can further includes a parking control button 17 connected to the first microprocessor 12 for controlling the parking of the car 20.

While we have shown and described the embodiment in accordance with the present invention, it should be clear to those skilled in the art that further embodiments may be made without departing from the scope of the present invention.

What is claimed is:

1. An electric car having remote calling control system, comprises:
a position transmitter carried by a caller for producing a azimuth signal, comprises:
an electronic compass module having a sensor for detecting the terrestrial magnetism and producing a first azimuth data of the caller;
a first microprocessor converting the first azimuth data into the first azimuth signal;
an encoder encoding the first azimuth signal; and
a radio frequency transmitter which transmits the first azimuth signal; and
a car comprises:
a car body having at least one front wheel installed at the front end of the car body;
two driving wheels installed on both sides of the car body;
an electronic compass detecting the terrestrial magnetism and producing a second azimuth data for the driving direction of the car;
a position receiver receiving the first azimuth signal comes from the radio frequency transmitter;
a decoder decoding the received first azimuth signal;
a second microprocessor which converts the second azimuth data into a second azimuth signal
a driving controller;
at least one electric motor which drives the driving wheel to rotate according to a command from the driving controller; and
at least one battery which supplies the required power;
when the caller uses the position transmitter to aim at the car, the electronic compass module detects the terrestrial magnetism and produces the first azimuth data of the caller, the microprocessor converts the first azimuth data to the first azimuth signal, and the radio frequency transmitter transmits the first azimuth signal to the position receiver of the car and input into the second microprocessor, also the electronic compass of the car detects the terrestrial magnetism and produces the second azimuth data and input into the second microprocessor and converted to the second azimuth signal, the second processor compares the first azimuth signal with the second azimuth signal and computes an azimuth difference, and the azimuth difference be used as a signal for controlling the movements of said car, and if the azimuth difference is zero, the car aims at the caller and moves forward, and if the azimuth difference is not zero, the second processor sends a signal for turning direction to the driving controller, and the driving controller controls the motor to drive so that the car be turned from its original position until said azimuth difference becomes zero, and then the car moves forward.

2. The car as claimed in claim 1, wherein the car is a golf car having a containing rack for storing golf balls and equipments.

3. The car as claimed in claim 1, wherein the car has two motors and each motor is responsible for driving a corresponding driving wheel, the driving controller can output two different control signals to the two motors so that the two driving wheels can produce a relative rotary speed difference to turn the direction of the car from its original position.

4. A method for calling a remote electric car, comprising:
a caller using a position transmitter to aim at a desired car, so that the position transmitter produces a first azimuth signal, and the first azimuth signal being produced by the direction of terrestrial magnetism and the direction of the position transmitter, and transmitting the first azimuth signal to the car;
the car producing a second azimuth signal, and the second azimuth signal being produced by the direction of terrestrial magnetism and the driving direction of the car;
the car receiving the first azimuth signal come from the transmitter of the caller; and
comparing the first azimuth signal with the second azimuth signal and computing an azimuth difference, and the azimuth difference being used as a signal for controlling the movements of the car, and the principle of controlling the movements of the car comprising:
(a) if the azimuth difference is zero, it means that the traveling direction of the car aims at the caller, and the car will move forward; and
(b) if the azimuth difference is not zero, the direction of the car will be turned from its original position until said azimuth difference becomes zero, and then the car will move forward.

5. The method as claimed in claim 4, wherein the position transmitter comprises an electronic compass module having a sensor for detecting terrestrial magnetism and producing the first azimuth data, and a processor converting the first azimuth data into the first azimuth signal.

6. The method as claimed in claim 4, wherein the position transmitter comprises a radio frequency transmitter for transmitting the first azimuth signal.

7. The method as claimed in claim 4, wherein the car installed an electronic compass thereon having a sensor for detecting terrestrial magnetism to produce the second azimuth data, and the second azimuth data converted into the second azimuth signal by a second microprocessor.

8. The method as claimed in claim 4, wherein the car installed a position receiver thereon for receiving the first azimuth signal transmitted from the position transmitter.

9. The method as claimed in claim 4, wherein the first azimuth signal is generated by detecting terrestrial magnetism by a sensor of a electronic compass module for producing the first azimuth data, and the first azimuth data is converted into the first azimuth signal by a first microprocessor, and the second azimuth data is generated by detecting terrestrial magnetism by a sensor of a electronic compass module, and the second azimuth data is converted into the second azimuth signal by a second processor, and the first azimuth data and the second azimuth data use the pointing line of the electronic compass module as a base, and said azimuth difference is obtained by subtracting the second azimuth from the inverted angle of the first azimuth; if the azimuth difference is positive, then said car will be controlled to turn counterclockwise from its original position until the azimuth difference becomes zero; and if the azimuth difference is negative, then the car will be controlled to turn clockwise from its original position until the azimuth difference becomes zero.
